(19) United States
(12) Patent Application Publication
(10) Pub. No.: US 2016/0010847 A1
(43) Pub. Date: Jan. 14, 2016

(54) Baton Combination Tool

(71) Applicant: Jaeger Arneaux Bellows, Laporte, MN (US)

(72) Inventor: Jaeger Arneaux Bellows, Laporte, MN (US)

(21) Appl. No.: 14/634,397

(22) Filed: Feb. 27, 2015

Related U.S. Application Data
(60) Provisional application No. 61/950,951, filed on Mar. 11, 2014.

(51) Int. Cl. F21V 33/00; F21L 4/00; F21V 14/08; F21V 23/04

(52) U.S. Cl. CPC F21V 33/0076; F21V 23/0414; F21L 4/00; F21V 14/085

(57) ABSTRACT

A baton combination tool is provided that comprises an elongated baton body portion and an orthogonal handle grip extending therefrom. Several tools are imbedded into the tool for increased access efficiency and improved carriage thereof. The first end of the baton body includes a glass breaker implement. The second end thereof comprises one of a chemical spray holster or a cutting implement extendable therefrom. Along the length of the baton body portion is a high intensity light that is controlled via a switch along the distal end of the handle grip. A slidable filter lens is provided for the light source, while an elongated strip of fasteners is further provided along the baton body portion. The fasteners allow for temporary support on the user's body when the user needs his or her hands free without holstering the baton.

### CROSS REFERENCE TO RELATED APPLICATION

This application claims the benefit of U.S. Provisional Application No. 61/950,951 filed on Mar. 11, 2014. The above identified patent application is herein incorporated by reference in its entirety to provide continuity of disclosure.

### BACKGROUND OF THE INVENTION

### Field of the Invention

The present invention relates to personal defense devices and tactical devices. More specifically, the present invention relates to a handheld baton device that includes several utilitarian features offering users a combination tool in compact form.

Police officers, private security, and military personnel generally employ several non-lethal self-defense or tactical devices to carry out their duties. These generally include batons, flashlights, non-lethal chemical sprays, cutting tools, and other defensive tools. In urgent situations, ready access to each tool is paramount. Professionals in such occupations can face life-threatening situations with little warning, therefore access to a specific tool carried on the user's person is important to minimize risk of injury and to evade harm. Generally these several tools are carried independently from one another. Since this can lead to inefficient access and unnecessary mass, a combination tactical device is desired—one that combines several functions into a more compact, readily accessible design.

The present invention provides a handheld tactical device that is designed to reduce the number of items a user must carry while operating in a tactical or defensive posture. The device provides a plurality of tools in one organized unit, thereby allowing a user to locate and employ a necessary tool with efficiency. The device ensures that law enforcement, private security, military personnel, and even private users have a reliable combination tool that is designed to improve security of the user and provide ready access to several necessary items.

More specifically, the present invention relates to a handheld baton tool that includes a high intensity light source, a glass breaker, a chemical spray canister holster, and an optional cutting tool. These items are supported within a baton that can be utilized as an impact instrument or defensive tool, whereby the device comprises a substantial T-shape having an elongated body potion and an upstanding handle grip orthogonally extending therefrom. The goal of the present invention is to increase efficiency of carriage and of access to several tactical items, while also increasing safety of the individual by facilitating ready access and compact stowage.

### SUMMARY OF THE INVENTION

In view of the foregoing disadvantages inherent in the known types of tactical baton devices now present in the prior art, the present invention provides a new baton combination device that can be utilized for providing convenience for the user when combining several self-defense and tactical elements into a single, compact device.

It is therefore an object of the present invention to provide a new and improved baton device that has all of the advantages of the prior art and none of the disadvantages.

It is another object of the present invention to provide a baton combination device that comprises a substantial T-shape, whereby the elongated body portion of the baton providing a handle grip for handling and employing the tool as a defensive or offensive instrument.

Another object of the present invention is to provide a baton combination device that includes a high intensity light source within the baton body portion and a control switch therefor along the distal end of the handle grip, facilitating light application when the tool is held in a defensive posture.

Yet another object of the present invention is to provide a baton combination device that includes a baton body portion with a first end supporting a glass breaker implement, and a second end comprises one of either a chemical spray support or extendable cutting tool imbedded therein.

Another object of the present invention is to provide a baton combination device that includes an elongated strip of fasteners along the side of the baton body, whereby the tool can be affixed to the chest of the wearer when temporarily stowed for hands-free support and quick access thereafter.

Another object of the present invention is to provide a baton combination device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the baton combination tool of the present invention.

FIG. 2 shows a close-up view of the light source of the tool and the slidable lens positionable thereover.

FIG. 3 shows an embodiment of the second end of the tool, whereby an embedded cutting implement is provided therein.

### DETAILED DESCRIPTION OF THE INVENTION

Reference is made herein to the attached drawings. Like reference numerals are used throughout the drawings to depict like or similar elements of the baton combination tool of the present invention. For the purposes of presenting a brief and clear description of the present invention, the preferred embodiment will be discussed as used for providing a tactical or defensive combination tool that can be utilized privately, by security personnel, or by other professionals in tactical environments wherein several tools may be desired. The figures are intended for representative purposes only and should not be considered to be limiting in any respect.

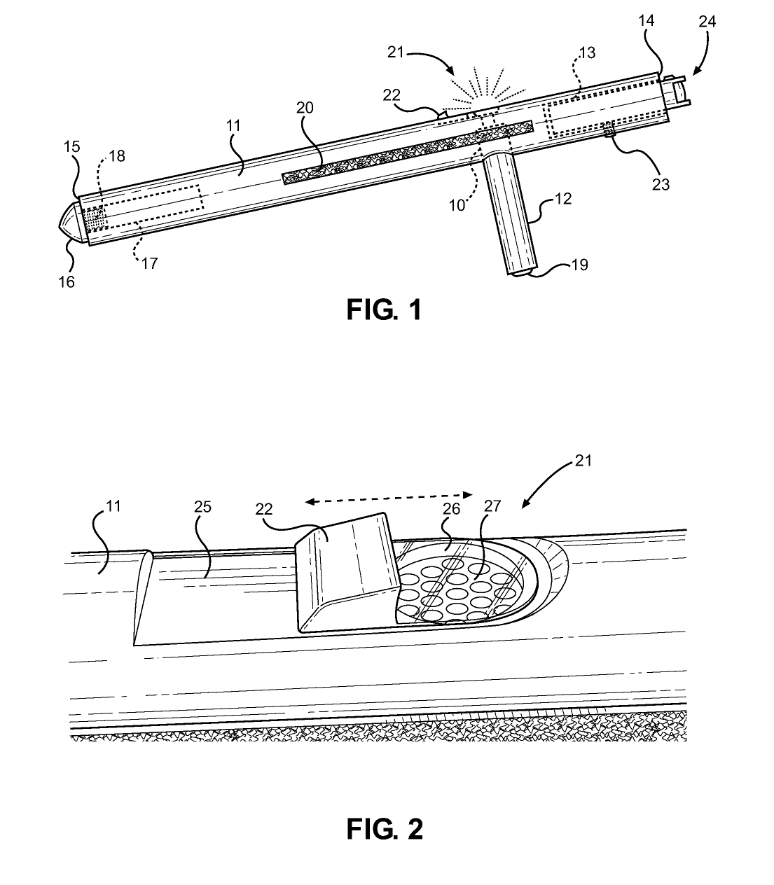

Referring now to FIG. 1, there is shown a side view of the baton combination tool of the present invention. The baton tool comprises a baton body portion 11 having an elongated length, a first end 15, and a second end 14. Along the elongated length is a handle grip 12, which extend substantially orthogonal to the body portion 11 and includes a distal end and a proximal end. The proximal end of the handle grip 12 secures to the baton body portion 11, while the distal end thereof provides a push button activation switch 19 for a light source 21 disposed along the body portion 11.

Along the length of the body portion 11 and preferably disposed along an opposite side of the baton is a high intensity light source 21. The baton body portion 11 is preferably a cylindrical body, whereby the light source 21 and the handle grip 12 are deposed across from one another such that the handle grip 12 can be held and oriented towards the user while the light source 21 projects illumination forward of the user. In this way, the baton body portion 11 can be held across the user's body by one hand and along the forearm of the user while the light source 21 projects light in the direction the user is walking. This is a common defensive posture while holding a baton, and furthermore allows the user's free hand to hold a firearm or handle objects other than the baton.

The activation switch 19 is disposed along the distal end of the handle grip 12 such that the user can operate the switch 19 with the user's thumb, whereby the palm and fingers surround the handle grip and the base of the hand is depressed against the baton body portion 11. To temper the light source or to operate the light at a lower intensity, a slidable light filter 22 is provided along the baton length such that the filter can be positioned over the light source 21 or slid away and stowed within a defined channel.

While the tool is not being supported within the hands of the user, the baton can be holstered in a belt harness that typically comprises an enclosed ring connected to the belt of the carrier. The baton body portion 11 is positioned through the ring and the baton is supported at the intersection of the handle grip 12 and baton body portion 11 along the waist of the user. This is a common stow location for security and law enforcement personnel. The present invention also contemplates a temporary stow location along the body of the user, whereby temporary support of the baton may be required during urgent situations in which two hands are necessary, yet full holstering of the baton is not desired. Full holstering may not be desired for several reason, including the time required to holster the baton and the length of time required to then draw the baton from the holster again.

To improve efficiency, the present invention contemplates an elongated strip of fasteners 20 centrally along the length of the baton. The fasteners 20 extend in the longitudinal direction (along the length) of the baton and are disposed preferably ninety degrees apart from both the light source 21 and the handle grip around the baton cylindrical outer surface. Complimentary fasteners are positioned along the chest or body of the user, whereby the user can then quickly secure the baton in a temporary position on his or her chest when two hands are otherwise required. The fasteners are preferably an elongated length extending along the length of the baton body portion, and preferably comprise a strip of hook and loop fasteners with high grip strength.

Along the first end 15 of the baton body portion 11 is preferably a glass breaker implement 16. The glass breaker implement 16 comprises a hardened, pointed tip that allows a user to shatter glass with greater ease when the implement 16 is forced thereagainst. It is typical in law enforcement to break windows, either for entry access or to reach those in an emergency situation. The glass breaker implement 16 provides a pointed tip which facilitates glass breakage by concentrating the blow of the baton at a single point, causing fractures of the glass and instant breakage.

The power source for the light source 21 is a battery that is either positioned within the first end 15 of the baton or within the handle grip portion 12. The first end 15 may further comprise an elongated battery channel 17 within which one or more battery power sources are stowed. The batteries contact terminals that are in electrical connection with the light source 21, which extend through the body portion 11. Furthermore, the glass breaker implement 16 includes a threaded connection 18 with the battery channel 17 such that the implement 16 is removable from the first end 15.

Alternatively, the battery power source may be stowed within the handle grip 12 and within an interior channel 10 extending within the handle grip 12 to the power source 21. This location centralizes the mass of the battery, but may compromise the size and power of the battery given the smaller size of the handle grip 12 relative to the body portion 11. In either embodiment, the light source 21 derives electrical power from a battery disposed within the baton tool.

Turning to the second end 14 of the elongated baton body portion, there is provided a holster 13 for a chemical spray canister 24, such as mace or pepper spray. The holster 13 comprises an elongated, hollow channel within the second end 14 that allows a canister of chemical spray 24 to be positioned therein and its nozzle to be positioned outside of the holster 13. A set screw 23 extending through the walls of the body portion 11 and into the holster 13 locks the canister 24 within the holster 13 and prevents the same from sliding therefrom while the baton is in use.

The canister of chemical spray 24 can be used from its position within the baton by gripping the baton second end and depressing the trigger of the canister. This releases the chemical spray in the direction of the nozzle orientation, whereby the user can transition from a baton tool to a chemical spray by simply gripping the tool at a different location. This eliminates the need to reach for and withdraw a holstered canister of pepper spray or the like from the user's waist. The set screw 23 may a fastener that applies pressure to the wall of the canister 24 to frictionally lock the canister 24 therein. Alternatively, the set screw may be temporary holder for the spray canister, whereby the canister is releasable upon command. This may be preferred for independent use of the canister of chemical spray, either after the baton has been withdrawn or when the baton is holstered and just the spray is desired.

Referring now to FIG. 2, there is shown a close-up view of the light source 21 of the present invention. The light source 21 preferably comprises an array of high intensity light emitting diodes (LEDs) 27, which project outward from the baton body portion 11 and in an opposite direction relative to the axial direction of the handle grip portion. The light may also comprise an incandescent or alternatively light source that is suitable for illuminating a dim area or for performing tactical operations in low light and night environments. Adjacent to the light source 21 is an elongated light filter channel 25 that is configured to receive therein a slidable light filter 26. The light filter 26 comprises a surface having a specific color or transparency that reduces light transfer therethrough. The filter 26 is used to dim the light or to deploy a desired low light when high intensity lighting is not desired. The light filter surface is sized to be coextensive with the light source when positioned thereover, whereby the filter is slidable within the channel 25 using the slider tab 22. The slider tab 22 is an upstanding projection that allows the user to force the filter over the light source 21 and dim its projection of light.

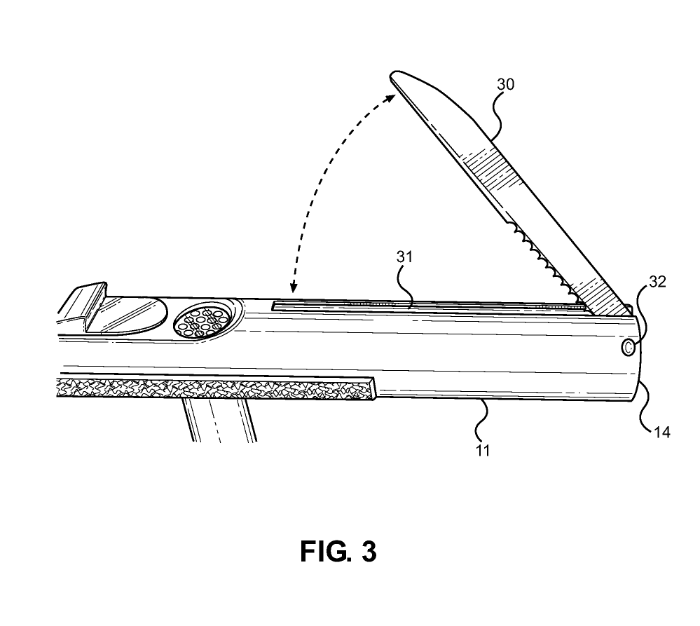

Referring finally to FIG. 3, there is shown an embodiment of the present invention in which the chemical spray holster is replaced with a utility knife end. The knife end embodiment comprises an elongated slot 31 extending along the length of the baton body 11 from the second end 14. The slot 31 is sized to receive the length, thickness, and height of a deployable utility knife 30, which is preferably pinned to the second end 14 using a pin joint 32. The utility knife 30 therefore pivots from the pin joint 32 from a stowed position within the slot 31, to an extended position in alignment with the length (axial direction) of the baton body 11. An internal locking mechanism may be disposed within the second end 14 to operably lock the knife 30 in an extended position. In use the knife can be used to cut objects when in the field, whereby a separate knife tool is no longer required. The knife 30 itself has at least one cutting edge and may have serrations therealong. When stowed, the knife is preferably completely retained within the interior of the slot 31, whereby the body of the knife is not overly exposed. The user can still grasp the knife to deploy the same.

Overall, the present invention provides a device that is designed to reduce the number of items an officer must carry while working. The device provides a plurality of tools in one organized unit, thereby allowing an officer to locate and access a necessary tool quickly. The device ensures law enforcement or military personnel have a reliable impact tool with a flashlight and other accessories, thereby providing a benefit for police officers, military agents, security guards and related professions.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A baton combination tool, comprising:
an elongated baton body having a first end, a second end, and an elongated length;
a handle grip extending substantially orthogonally from said baton body, said handle grip having a distal end;
a light source disposed along said baton body, said light source being disposed along an opposite side of said baton body with respect to said handle grip;
the first end of said baton body further comprising a glass breaker implement;
the second end of said baton body further comprising a holster configured to support the body of a chemical spray canister therein, said holster comprising a hollow channel within the second end to receive the chemical spray canister.

2. The baton combination tool of claim 1, wherein the distal end of said handle grip further comprises an activation switch for the light source.

3. The baton combination tool of claim 1, wherein the handle grip supports one or more battery power sources in electrical connection with the light source.

4. The baton combination tool of claim 1, wherein:
the first end of the baton body further comprises an elongated battery channel within which one or more battery power sources are supported in electrical connection with the light source; and
wherein said glass breaker implement is removable from the first end of the baton body to access the elongated battery channel.

5. The baton combination tool of claim 1, further comprising:
an elongated strip of fasteners extending along the baton body along its length, whereby the strip of fasteners is positioned between the handle grip and the light source around the baton body such that the elongated strip of fasteners can affix to complimentary fasteners on a wearer's body such that the handle grip is substantially parallel to the wearer.

6. The baton combination tool of claim 1, further comprising a light filter slidable over the light source, whereby the light filter is slidable within a light filter channel adjacent to the light source along the baton body.

7. The baton combination tool of claim 1, wherein the second end of the baton body further comprises a set screw extending into the holster to secure the chemical spray canister therein.

8. A baton combination tool, comprising:
an elongated baton body having a first end, a second end, and an elongated length;
a handle grip extending substantially orthogonally from said baton body, said handle grip having a distal end;
a light source disposed along said baton body, said light source being disposed along an opposite side of said baton body with respect to said handle grip;
the first end of said baton body further comprising a glass breaker implement;
the second end of said baton body further comprising an elongated slot and a utility knife pivotably connected to the second end;
said elongated slot sized to receive the utility knife therein when the utility knife is in a stowed state.

9. The baton combination tool of claim 8, wherein the distal end of said handle grip further comprises an activation switch for the light source.

10. The baton combination tool of claim 8, wherein the handle grip supports one or more battery power sources in electrical connection with the light source.

11. The baton combination tool of claim 8, wherein:
the first end of the baton body further comprises an elongated battery channel within which one or more battery power sources are supported in electrical connection with the light source; and
wherein said glass breaker implement is removable from the first end of the baton body to access the elongated battery channel.

12. The baton combination tool of claim 8, further comprising:
an elongated strip of fasteners extending along the baton body along its length, whereby the strip of fasteners is positioned between the handle grip and the light source around the baton body such that the elongated strip of fasteners can affix to complimentary fasteners on a wearer's body such that the handle grip is substantially parallel to the wearer.

13. The baton combination tool of claim 8, further comprising a light filter slidable over the light source, whereby the light filter is slidable within a light filter channel adjacent to the light source along the baton body.

14. A baton combination tool, comprising:
an elongated baton body having a first end, a second end, and an elongated length;
a handle grip extending substantially orthogonally from said baton body, said handle grip having a distal end;
a light source disposed along said baton body, said light source being disposed along an opposite side of said baton body with respect to said handle grip;
an elongated strip of fasteners extending along the baton body along its length, whereby the strip of fasteners is positioned between the handle grip and the light source around the baton body such that the elongated strip of fasteners can affix to complimentary fasteners on a wearer's body such that the handle grip is substantially parallel to the wearer.

15. The baton combination tool of claim 14, wherein the distal end of said handle grip further comprises an activation switch for the light source.

16. The baton combination tool of claim 14, wherein the handle grip supports one or more battery power sources in electrical connection with the light source.

17. The baton combination tool of claim 14, wherein:
the first end of the baton body further comprises an elongated battery channel within which one or more battery power sources are supported in electrical connection with the light source; and
wherein said glass breaker implement is removable from the first end of the baton body to access the elongated battery channel.

18. The baton combination tool of claim 14, further comprising a light filter slidable over the light source, whereby the light filter is slidable within a light filter channel adjacent to the light source along the baton body.

19. The baton combination tool of claim 14, wherein:
the second end of said baton body further comprising a holster configured to support the body of a chemical spray canister therein, said holster comprising a hollow channel within the second end to receive the chemical spray canister.

20. The baton combination tool of claim 14, wherein:
the second end of said baton body further comprising an elongated slot and a utility knife pivotably connected to the second end;
said elongated slot sized to receive the utility knife therein when the utility knife is in a stowed state.
